(19) United States
(12) Patent Application Publication
(10) Pub. No.: US 2009/0289757 A1
(43) Pub. Date: Nov. 26, 2009

(54) SYSTEM FOR REMOTE CONTROL USING A WAP-ENABLED DEVICE

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/471,176

(22) Filed: May 22, 2009

Related U.S. Application Data
(60) Provisional application No. 61/055,714, filed on May 23, 2008.

(51) Int. Cl. G06F 13/42; G05B 23/02

(52) U.S. Cl. 340/3.1; 340/825

(57) ABSTRACT

Provided is a system for remote control using a Wireless Application Protocol (WAP) enabled device. In one example, the system is positioned within a vehicle and includes a wireline interface coupled to a plurality of vehicle components via a wireline connection to a communications network positioned within the vehicle, a wireless interface configured to send and receive wireless signals, and a control module. The control module has a processor coupled to the wireline and wireless interfaces and a memory coupled to the processor. The memory includes a plurality of instructions for execution by the processor.

### CROSS-REFERENCE TO RELATED APPLICATIONS

This application is a non-provisional patent application of U.S. Provisional Application for Patent Ser. No. 61/055,714, filed May 23, 2008, and entitled SYSTEM FOR REMOTE CONTROL USING WAP-ENABLED DEVICE, the specification of which is incorporated herein in its entirety.

### TECHNICAL FIELD

The following disclosure relates to control systems and, more particularly, to remotely controlling functions using a wireless device.

### BACKGROUND

It is well known that control systems are used in vehicles and structures. In a vehicle, such functions may range from necessary functions such as speed control and steering to comfort oriented functions such as air conditioning and sound system control. In a structure, such functions may range from security and alarm systems to environmental control systems. However, such control systems are generally automated or controllable only through a hard-wired interface. Therefore, a need exists for a more flexible and convenient way to manipulate control systems associated with a vehicle or a structure.

### SUMMARY

In one embodiment, a system positioned within a vehicle for wireless communication between the vehicle and a wireless device is provided. The system includes a wireline interface coupled to a plurality of vehicle components via a wireline connection to a communications network positioned within the vehicle, a wireless interface configured to send and receive wireless signals, and a control module. The control module has a processor coupled to the wireline and wireless interfaces and a memory coupled to the processor. The memory includes a plurality of instructions for execution by the processor, the instructions including instructions for obtaining information regarding a state of at least one of the plurality of vehicle components via the wireline interface based on a first instruction received from the wireless device via the wireless interface, instructions for sending at least a portion of the obtained information to the wireless device via the wireless interface, and instructions for sending a control signal to at least one of the plurality of vehicle components via the wireline interface based on a second instruction received from the wireless device via the wireless interface.

In another embodiment, a remote access system for a vehicle is provided. The remote access system comprises a plurality of vehicle components, a plurality of vehicle control systems, a vehicle communication network, and a control module. Each of the plurality of vehicle control systems is associated with at least one of the plurality of vehicle components. The vehicle communication network is coupled to the plurality of vehicle control systems. The control module is coupled to the vehicle communication network and has first and second communication interfaces, a processor, and a memory. The first communication interface is coupled to the vehicle communication network and at least the second communication interface is wireless. The processor is coupled to the first and second communication interfaces. The memory is coupled to the processor and includes a plurality of instructions for execution by the processor. The instructions include instructions for communicating with a Wireless Application Protocol (WAP) enabled wireless device via the wireless communication interface, wherein communicating with the wireless device includes receiving a request from the wireless device and responding to the request with information. The instructions also include instructions for processing the request from the wireless device to determine the information being requested, and instructions for obtaining the information being requested from at least one of the plurality of vehicle control systems.

In yet another embodiment, a remote access system for a building is provided. The remote access system includes a plurality of control systems associated with the building, a communication network coupled to the plurality of control systems, and a control module. The control module has a communication interface, a processor, and a memory. The communication interface is coupled to the communication network and includes at least a wireless portion configured to receive and transmit wireless signals. The processor is coupled to the communication interface. The memory is coupled to the processor and includes a plurality of instructions for execution by the processor. The instructions include instructions for communicating with a Wireless Application Protocol (WAP) enabled wireless device via the wireless portion of the communication interface, wherein communicating with the wireless device includes receiving a request from the wireless device, and instructions for performing at least one action in response to the request, wherein the instructions for performing the at least one action include instructions for identifying one of the plurality of control systems corresponding to the at least one action and instructions for sending a message to the identified control system to initiate the at least one action.

### BRIEF DESCRIPTION OF THE DRAWINGS

For a more complete understanding, reference is now made to the following description taken in conjunction with the accompanying Drawings in which:

FIG. 1a illustrates one embodiment of an environment in which aspects of the present disclosure may be implemented;

FIG. 1b illustrates another embodiment of an environment in which aspects of the present disclosure may be implemented;

FIG. 2 illustrates one embodiment of a vehicle in which aspects of the present disclosure may be implemented;

FIG. 3 illustrates one embodiment of a control module that may be used with the vehicle of FIG. 2;

FIG. 4 illustrates one embodiment of a wireless device that may be used to remotely communicate with the control module of FIG. 3;

FIG. 5 is a sequence diagram illustrating one embodiment of a method by which the wireless device of FIG. 4 may request information from the control module of FIG. 3;

FIG. 6 is a sequence diagram illustrating one embodiment of a method by which the control module of FIG. 3 may push information to the wireless device of FIG. 4;

FIG. 7 is a sequence diagram illustrating one embodiment of a method by which the wireless device of FIG. 4 may send instructions to the control module of FIG. 3; and

FIG. 8 illustrates yet another embodiment of an environment in which aspects of the present disclosure may be implemented.

### DETAILED DESCRIPTION

Although the preferred embodiment has been described in detail, it should be understood that various changes, substitutions and alterations can be made therein without departing from the spirit and scope of the invention as defined by the appended claims.

The following disclosure describes remotely controlling all or portions of a vehicle or a structure. The term “vehicle” may include any artificial mechanical or electromechanical system capable of movement (e.g., motorcycles, automobiles, trucks, boats, and aircraft), while the term “structure” may include any artificial system that is not capable of movement. Although both a vehicle and a structure are used in the present disclosure for purposes of example, it is understood that the teachings of the disclosure may be applied to many different environments and variations within a particular environment. Accordingly, the present disclosure may be applied to vehicles and structures in land environments, including manned and remotely controlled land vehicles, as well as above ground and underground structures. The present disclosure may also be applied to vehicles and structures in marine environments, including ships and other manned and remotely controlled vehicles and stationary structures (e.g., oil platforms and submersed research facilities) designed for use on or under water. The present disclosure may also be applied to vehicles and structures in aerospace environments, including manned and remotely controlled aircraft, spacecraft, and satellites.

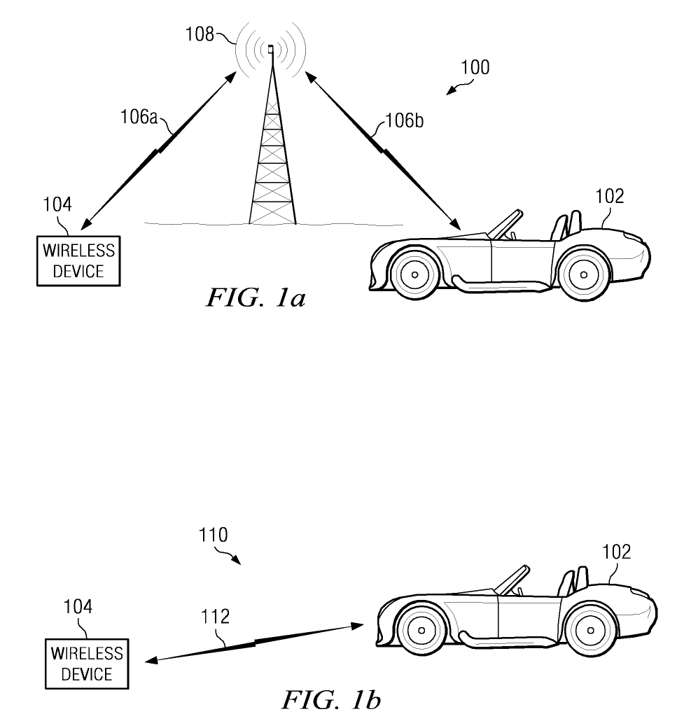

Referring to FIG. 1a, one embodiment of an environment 100 is illustrated in which a user (not shown) may wirelessly control one or more functions of a vehicle 102 using a wireless device 104. In the present example, as will be described later in greater detail, the wireless device 104 is capable of communicating with the vehicle 102 over a wireless channel that is formed by links 106a and 106b. The link 106a couples the wireless device 104 to a network 108 (e.g., a cell network) and the link 106b couples the vehicle 102 to the network. Using the wireless channel provided by the links 106a and 106b, the wireless device 104 may receive information from the vehicle 102 and may send instructions to the vehicle.

Referring to FIG. 1b, in another embodiment, an environment 110 illustrates a direct connection between the vehicle 102 and wireless device 104 using a single link 112. For example, the vehicle 102 may provide an access point (e.g., a WiFi access point) and the wireless device may use the access point to establish the link 112 in order to communicate with the vehicle.

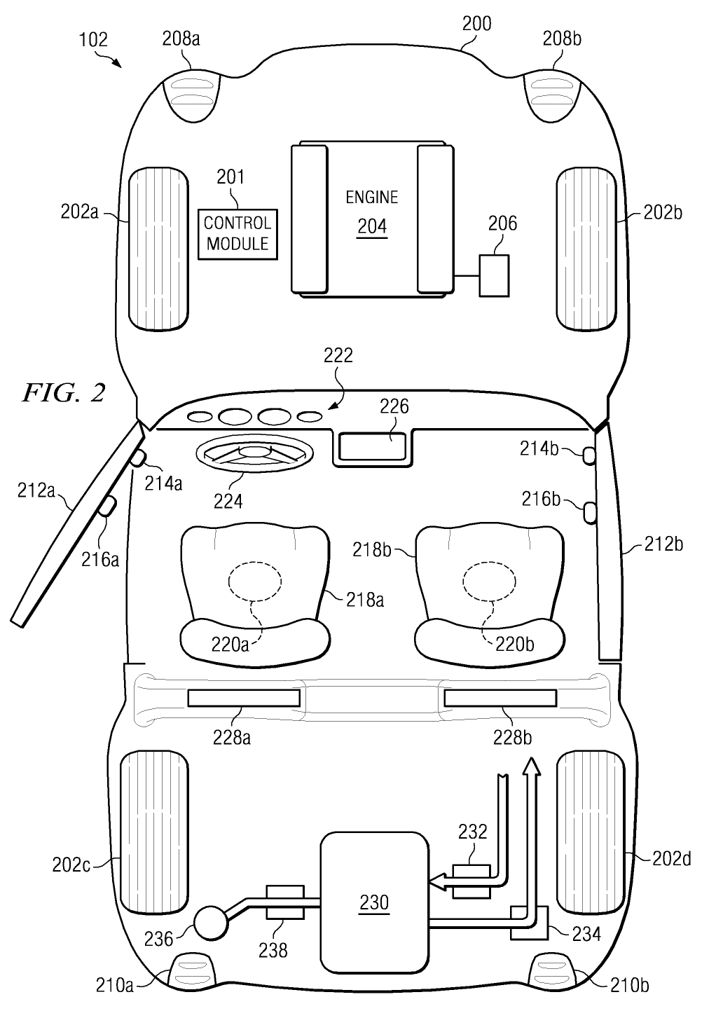

Referring to FIG. 2, one embodiment of the vehicle 102 of FIGS. 1a and 1b is illustrated. The vehicle 102 includes a chassis 200 and positioned within or coupled to the chassis are a plurality of components and corresponding control systems that interact to provide propulsion, steering, braking, and other functionality to the vehicle 102. It is understood that the components and control systems described herein are for purposes of example only, and that many other components and control systems may be used with the vehicle 102. Furthermore, illustrated components and control systems may be configured differently from those illustrated and may be positioned in different positions within the vehicle 102.

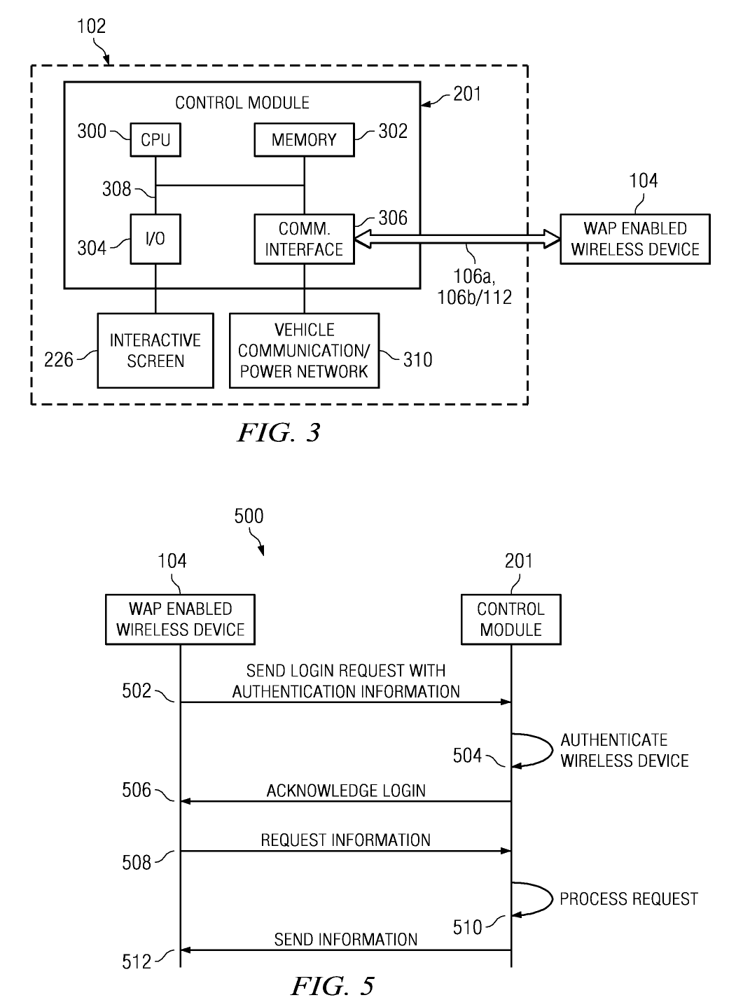

The vehicle 102 includes a control module 201. The control module 201 may represent a plurality of control modules or may be a centralized controller. As will be discussed below in greater detail with reference to FIG. 3, the control module 201 may be coupled to some or all of the components and control systems of the vehicle 102 via a communications network for monitoring and/or control purposes.

The vehicle 102 further includes tires 202a, 202b, 202c, and 202d that are powered via an engine 204. An Engine Control Unit (ECU) 206 may monitor and manage the performance of the engine 204. For example, the ECU 206 may control fuel injection in the engine 204 based on monitored parameters. Headlight assemblies 208a and 208b and tail light assemblies 210a and 210b may be coupled to an electrical system that enables manipulation of various lights forming the headlight and tail light assemblies by, for example, the control module 201.

Doors 212a and 212b may be monitored using “door ajar” sensors 214a and 214b, respectively. “Door open” switches 216a and 216b may be used to control interior lights, alarms, and other functions when doors 212a and 212b, respectively, are opened. Driver seat 218a and passenger seat 218b may include presence sensors 220a and 220b, respectively, that indicate the presence of a person. The passenger compartment may also contain a gauge cluster 222 for providing feedback information to the driver (e.g., speed, fuel level, and engine temperature) and various actuation means (e.g., switches and buttons) positioned on a steering wheel 224.

An interactive navigation and information screen 226 (e.g., a flat panel) may also be positioned in the passenger compartment. The interactive screen 226 may be used to provide navigation information, vehicle information (e.g., a current fuel level, estimated remaining mileage before fuel is needed, and various temperatures (e.g., engine and passenger compartment temperatures)), and other information to a user. In some embodiments, the interactive screen 226 may be a touchscreen control panel that enables a user to interact with the control module 201. For example, the user may use the interactive screen 226 to request information about the vehicle 102 or adjust the temperature in the passenger compartment. In different embodiments, various combinations of functions may be monitored and/or controlled to provide different levels of user interaction with the vehicle 102.

Rollbar light assemblies 228a and 228b may be coupled to an electrical system that enables manipulation of various lights on the rollbar light assemblies via, for example, the control module 201. A fuel cell 230 may be coupled to a flow meter 232 that measures fluid flow on a low pressure fuel return from the engine 204 and a flow meter 234 that measures fluid flow on a high pressure fuel line to the engine. A fuel cap 236 may cover a fuel fill line that is monitored by a flow meter 238. Although not shown, a sensor may monitor the fuel cap 236 to ensure that it is in place. The fuel cell 230 and the various flow meters 232, 234, and 238 may be monitored by the control module 201.

It is understood that the vehicle 102 may include a variety of control systems (not all shown) configured to monitor and/or control vehicle functions such as ignition, propulsion, steering, braking, oil and tire pressure, control panel indicators, passenger compartment environmental parameters (e.g., temperature and air flow), and audio/video entertainment system settings. Such control systems may range from complex (e.g., fuel injection as managed by the ECU 206) to relatively simple (e.g., control of an interior “dome” light). Some or all of these systems may be monitored and/or controlled by the control module 201. In other embodiments, even if the systems are not directly monitored by the control module 201, the control module may be capable of requesting information about such systems either directly from the system itself or through another system.

Referring to FIG. 3, one embodiment of the control module 201 of FIG. 2 is illustrated. The control module 201 may include components such as a central processing unit (“CPU”) 300, a memory unit 302, an input/output (“I/O”) device 304, and a communication interface 306. The communication interface may be, for example, one or more network interface cards or chips (NICs) that are each associated with a media access control (MAC) address. The components 300, 302, 304, and 306 are interconnected by one or more communication links 308 (e.g., a bus).

It is understood that the control module 201 may be configured in many different ways and that each of the listed components may actually represent several different components. For example, the CPU 300 may actually represent a multi-processor or a distributed processing system; the memory unit 302 may include different levels of cache memory, main memory, hard disks, and remote storage locations; and the I/O device 304 may include monitors, keyboards, and the like, and/or ports for attaching such devices. In the present example, the I/O device 304 is coupled to the interactive screen 226. The communication interface 308 may have both wireline and wireless interfaces that provide the control module 201 with a wireline connection to a communication/power network 310 within the vehicle 102 and a wireless connection to the wireless device 104 via a wireless channel.

In the present example, the wireless device 104 is capable of communicating using the Wireless Application Protocol (WAP). For example, the wireless device 104 may send and receive packet data formatted according to WAP. The terms “packet” and “packet data,” as used in the present disclosure, are interchangeable and may include any type of encapsulated data, including datagrams, frames, packets, and the like, and the encapsulated information may include voice, video, data, and/or other information.

As is known, WAP is an open standard that defines a set of communication protocols for use in providing content to wireless devices over many different air interfaces. As such, WAP may be used over a bearer channel provided by different network technologies, including Code Division Multiple Access (CDMA), Global System for Mobile Communications (GSM), Time Division Multiple Access (TDMA), Short Message Service (SMS), High-Speed Circuit-Switched Data (CSD), General Packet Radio Service (GPRS), and Unstructured Supplementary Services Data (USSD).

WAP includes a protocol suite having the WAP Datagram Protocol (WDP) as the lowest level protocol layer. Stacked above the WDP layer are a Wireless Transport Layer Security (WTLS) layer that provides a public-key cryptography-based security mechanism, a Wireless Transaction Protocol (WTP) layer that provides transaction support (e.g., reliable request/response), and a Wireless Session Protocol (WSP) layer that provides a connection mode and session layer. On some bearer types, such as native Internet Protocol (IP) bearers (e.g., General Packet Radio System (GPRS) and Universal Mobile Telecommunication System (UMTS) (i.e., 3G) packet-radio service), WDP is equivalent to the User Datagram Protocol (UDP). In some embodiments, WAP may also directly support IP protocols.

WAP may be used with many different operating systems, including operating systems designed specifically for use with wireless devices, such as PalmOS, EPOC, Windows CE, FLEXOS, OS/9, and JavaOS. It is understood that the use of WAP in the present disclosure is for purposes of example and that other wireless communication protocols may be used to implement various features of the present disclosure.

The control module 201 may be WAP enabled in order to communicate with the wireless device 104. For example, the control module 201 may include a Wireless Application Environment (WAE) server to handle WAP messaging. Alternatively, the control module 201 may include a HyperText Transfer Protocol (HTTP) server (i.e., a web server) that communicates with a WAP gateway using HTTP messaging and the WAP gateway may convert the HTTP based communications to WAP based communications before forwarding the communications to the wireless device 104. In the opposite direction, the WAP gateway may convert the WAP based communications of the mobile device 104 to HTTP based communications before forwarding the communications to the control module 201. In still other embodiments, the control module 201 may include or be connected to a wireless access point located within the vehicle 102, and may use the wireless access point to communicate with the wireless device 104. For example, the wireless access point may provide a WiFi connection for direct communication between the control module 201 and the wireless device 104.

Accordingly, depending on the configuration of the control module 201, packet data may be sent to and received from the wireless device 104 either directly or indirectly through a gateway. It is understood that sending and receiving the packet data “directly” may include the use of one or more bearer channels over a network (e.g., a cell network), but not the use of a gateway. As the network providing the bearer channels may support long distance communication, the control module 201 may be accessible to the wireless device 104 over relatively large distances.

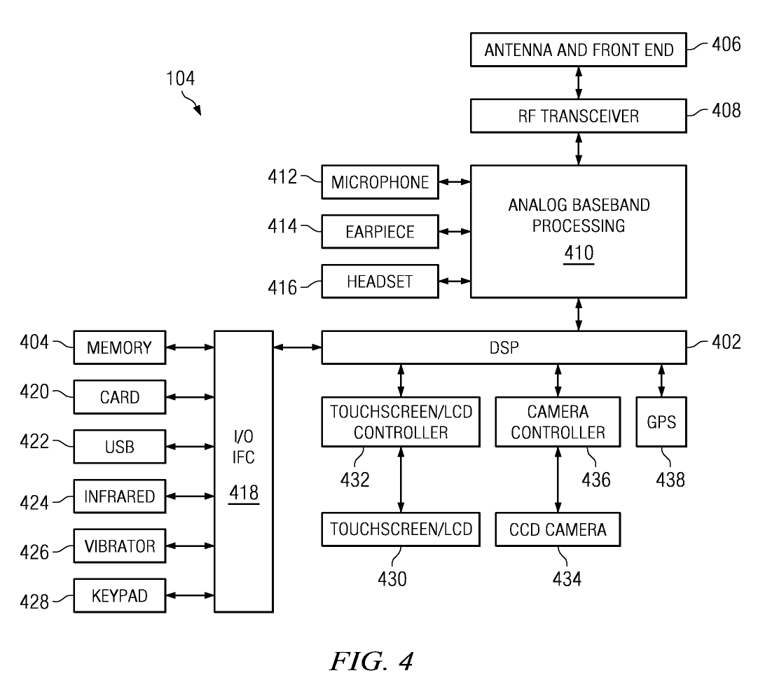

Referring to FIG. 4, one embodiment of the wireless device 104 of FIG. 1 is illustrated as including many different components. However, it is understood that in other embodiments the wireless device 104 may not have all of the illustrated components and may be configured differently than that shown in the present example. For example, the wireless device 104 may be a computer, personal digital assistant (PDA), cellular telephone, or any other device capable of transmitting, processing, and receiving signals via a wireless link, and so may be configured differently depending on the particular type of device.

In the present example, the wireless device 104 includes a processor 402 (e.g., a digital signal processor (DSP)) and a memory 404. As shown, the wireless device 104 may further include an antenna and front end unit 406, a radio frequency (RF) transceiver 408, an analog baseband processing unit 410, a microphone 412, an earpiece speaker 414, a headset port 416, an input/output interface 418, a removable memory card 420, a universal serial bus (USB) port 422, an infrared port 424, a vibrator 426, a keypad 428, a touch screen liquid crystal display (LCD) with a touch sensitive surface 430, a touch screen/LCD controller 432, a charge-coupled device (CCD) camera 434, a camera controller 436, and a global positioning system (GPS) sensor 438.

The DSP 402 or some other form of controller or central processing unit operates to control the various components of the wireless device 104 in accordance with embedded software or firmware stored in memory 404. In addition to the embedded software or firmware, the DSP 402 may execute other applications stored in the memory 404 or made available via information carrier media such as portable data storage media like the removable memory card 420 or via wired or wireless network communications. The application software may comprise a compiled set of machine-readable instructions that configure the DSP 402 to provide the desired functionality, or the application software may be high-level software instructions to be processed by an interpreter or compiler to indirectly configure the DSP 402.

The antenna and front end unit 406 may be provided to convert between wireless signals and electrical signals, enabling the wireless device 104 to send and receive information from a cellular network or some other available wireless communications network. The RF transceiver 408 provides frequency shifting, converting received RF signals to baseband and converting baseband transmit signals to RF. The analog baseband processing unit 410 may provide channel equalization and signal demodulation to extract information from received signals, may modulate information to create transmit signals, and may provide analog filtering for audio signals. To that end, the analog baseband processing unit 410 may have ports for connecting to the built-in microphone 412 and the earpiece speaker 414 that enable the wireless device 104 to be used as a cell phone. The analog baseband processing unit 410 may further include a port for connecting to a headset or other hands-free microphone and speaker configuration.

The DSP 402 may send and receive digital communications with a wireless network via the analog baseband processing unit 410. In some embodiments, these digital communications may provide Internet connectivity, enabling a user to gain access to content on the Internet and to send and receive e-mail or text messages. The input/output interface 418 interconnects the DSP 402 and various memories and interfaces. The memory 404 and the removable memory card 420 may provide software and data to configure the operation of the DSP 402. Among the interfaces may be the USB interface 422 and the infrared port 424. The USB interface 422 may enable the wireless device 104 to function as a peripheral device to exchange information with a personal computer or other computer system. The infrared port 424 and other optional ports such as a Bluetooth interface or an IEEE 802.11 compliant wireless interface may enable the wireless device 104 to communicate wirelessly with other nearby mobile devices and/or wireless base stations.

The input/output interface 418 may further connect the DSP 402 to the vibrator 426 that, when triggered, causes the wireless device 104 to vibrate. The vibrator 426 may serve as a mechanism for silently alerting the user to any of various events such as an incoming call, a new text message, and an appointment reminder.

The keypad 428 couples to the DSP 402 via the interface 418 to provide one mechanism for the user to make selections, enter information, and otherwise provide input to the wireless device 104. Another input mechanism may be the touch screen LCD 430, which may also display text and/or graphics to the user. The touch screen LCD controller 432 couples the DSP 402 to the touch screen LCD 430.

The CCD camera 434 enables the wireless device 104 to take digital pictures. The DSP 402 communicates with the CCD camera 434 via the camera controller 436. The GPS sensor 438 is coupled to the DSP 402 to decode global positioning system signals, thereby enabling the wireless device 104 to determine its position. Various other peripherals may also be included to provide additional functions (e.g., radio and television reception).

It is understood that the wireless device 104 may include a plurality of executable instructions, including instructions for communication with the control module 201 of FIG. 2. Such instructions may be stored in the memory 404 and processed by the DSP 402. Accordingly, various aspects of following embodiments may be executed by the wireless device 104.

Referring to FIG. 5, a sequence diagram illustrates one embodiment of a method 500 by which the wireless device 104 (FIG. 1) may communicate with the vehicle 102 via the control module 201 (FIG. 2). The present example may occur in both of the environments 100 and 110 of FIGS. 1a and 1b, respectively. Accordingly, the connection between the vehicle 102 and the wireless device 104 may be direct or indirect as previously described. It is understood that the method 500 illustrates basic messaging and does not necessarily portray every message that may pass between the vehicle 102, wireless device 104, and any intervening network(s). For example, any needed handshake and call setup and teardown messages between a network and the vehicle 102 and wireless device 104 are not shown.

In step 502, the wireless device 104, which is WAP enabled in the present example, sends a login request to the control module 201 of the vehicle 102. The login request may contain authentication information (e.g., credentials such as username and password). In step 504, the control module 201 verifies the authentication information and, in step 506, sends a message to the wireless device 104 acknowledging the login. It is understood that step 506 may be a rejection message if the authentication information is not verified in step 504. In some embodiments, steps 502, 504, and 506 may be omitted.

In step 508, the wireless device 104 sends a request for information to the control module 201. The request may be for various types of information, such as diagnostic results, aggregated information from monitors within the vehicle 102, the current status of various components/control systems, etc. The request may also include parameters that specify a format for the information, provide filtering criteria, provide date/time ranges, and otherwise narrow the information requested. In step 510, the control module 201 may process the request, which may include querying various components and control systems for information, retrieving stored information, and assembling information for delivery to the wireless device 104. In some embodiments, the control module 201 may format the information specifically for display on a hand held device. In step 512, the control module 201 sends the information to the wireless device 104, which may then display the information to a user.

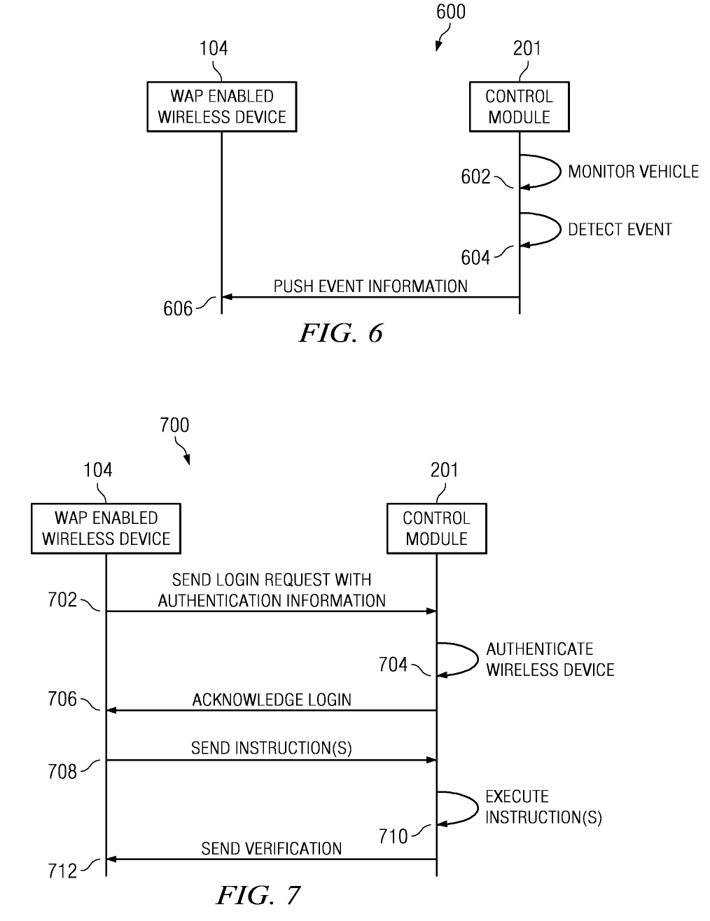

Referring to FIG. 6, a sequence diagram illustrates one embodiment of a method 600 by which the control module 201 (FIG. 2) of the vehicle 102 (FIG. 1) may push information to the wireless device 104. The present example may occur in both of the environments 100 and 110 of FIGS. 1a and 1b, respectively. Accordingly, the connection between the vehicle 102 and the wireless device 104 may be direct or indirect as previously described. It is understood that the method 600 illustrates basic messaging and does not necessarily portray every message that may pass between the vehicle 102, wireless device 104, and any intervening network(s). For example, any needed handshake and call setup and teardown messages between a network and the vehicle 102 and wireless device 104 are not shown.

In step 602, the control module 201 monitors one or more vehicle parameters. For example, the control module 201 may monitor an alarm state of the vehicle 102 or a temperature of the passenger compartment. The monitoring may occur in a repeating loop that ends at a specified time or when a specified parameter is met (e.g., the user unlocks the vehicle's doors). When the monitoring detects an event (e.g., the alarm is triggered or the temperature of the passenger compartment reaches a defined level), the control module 201 may push information detailing the event to the wireless device 104, which is WAP enabled in the present example. For example, the control module 201 may send a message to the wireless device 104 indicating that the alarm has been triggered or informing the user of the current temperature of the passenger compartment. Although not shown, the control module 201 may take other action when the event occurs, such as activating a fan to move air through the passenger compartment when the temperature reaches the defined level.

Referring to FIG. 7, a sequence diagram illustrates one embodiment of a method 700 by which the wireless device 104 (FIG. 1) may communicate with the vehicle 102 via the control module 201 (FIG. 2). The present example may occur in both of the environments 100 and 110 of FIGS. 1a and 1b, respectively. Accordingly, the connection between the vehicle 102 and the wireless device 104 may be direct or indirect as previously described. It is understood that the method 700 illustrates basic messaging and does not necessarily portray every message that may pass between the vehicle 102, wireless device 104, and any intervening network(s). For example, any needed handshake and call setup and teardown messages between a network and the vehicle 102 and wireless device 104 are not shown.

In step 702, the wireless device 104, which is WAP enabled in the present example, sends a login request to the control module 201 of the vehicle 102. The login request may contain authentication information (e.g., credentials such as username and password). In step 704, the control module 201 verifies the authentication information and, in step 706, sends a message to the wireless device 104 acknowledging the login. It is understood that step 706 may be a rejection message if the authentication information is not verified in step 704. In some embodiments, steps 702, 704, and 706 may be omitted.

In step 708, the wireless device 104 sends one or more instructions to the control module 201. In the present example, the instructions may include the ability to execute any function of which the control module 201 is capable of executing. In other embodiments, the instructions may be limited to prevent a user from performing specified actions remotely. For example, the wireless device 104 may be prohibited from starting the ignition and the control module 201 may be configured to ignore or reject such instructions from the wireless device.

In step 710, the control module 201 may execute the instructions. If the instruction set available to the wireless device 104 is limited, the control module 201 may first verify that the wireless device is permitted to execute a given instruction. In some embodiments, the control module 201 may prompt the wireless device 104 for additional authentication information. In such embodiments, some instructions may require another password for remote access. This enables the control module 201 to provide some functions when the wireless device 104 first authenticates while maintaining a higher level of security for other functions.

In step 712, the control module 201 may send a verification message to the wireless device 104. Alternatively, if the instructions were not executed, a message indicating this failure may be sent to the wireless device 104 with information detailing the reason for the failure (e.g., no remote access for an instruction or improper authentication credentials).

It is understood that security features may be provided to control remote access. As described above, security credentials such as a username and password may be required to access the control module 201 from the wireless device 104 and, in some embodiments, certain functions may require additional credentials. Security features may be maintained by the control module 201 and may also apply to the interactive screen 226. For example, the interactive screen 226 may have different levels of functionality that can be maintained with different levels of security. This allows other users (e.g., friends, valets, and mechanics) to have access to the vehicle 102 and enables different feature sets to be provided for each user. Furthermore, some features may be desirable in one setting, but not in others. For example, a speedometer or mileage alert may be activated for valet parking, but deactivated at all other times. In another example, a mechanic may find it helpful to remotely trigger various exterior lights using a wireless device 104. With bi-directional communication between the control module 201 and the wireless device 104, such features may be remotely monitored and also remotely activated and deactivated.

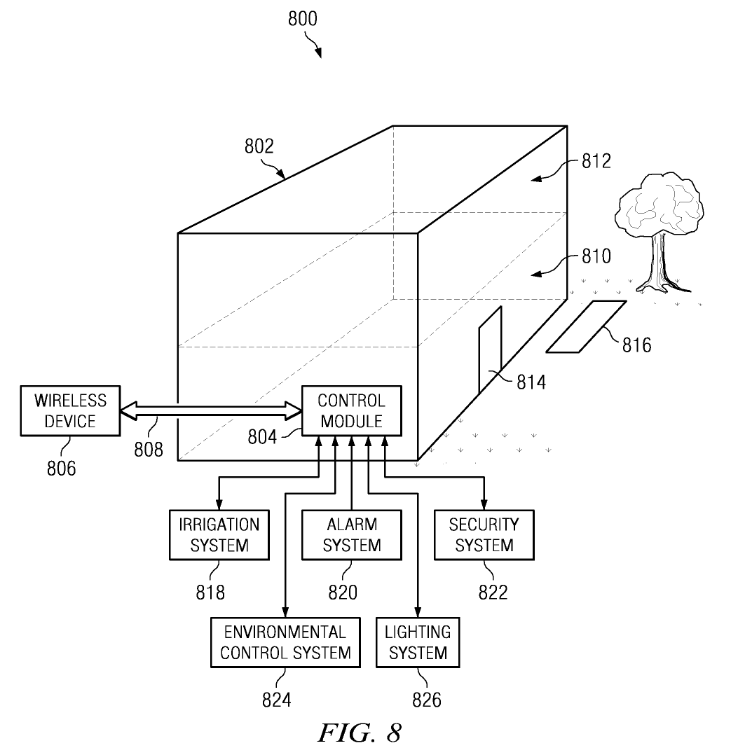

Referring to FIG. 8, in another embodiment, an environment 800 illustrates a structure 802 that contains a control module 804 capable of communicating with a wireless device 806 via a link 808. The control module 804 may be similar or identical to the control module 201 of FIG. 3, except that the control module 804 is coupled to one or more systems of the structure 802, as will be described below in greater detail. The wireless device 806 may be similar or identical to the wireless device 104 of FIG. 4. In some embodiments, the link 808 may represent multiple links between the control module 804 and the wireless device 806, such as the links 106a and 106b described with respect to FIG. 1a.

In the present example, the structure 802 is an above ground building that includes multiple floors 810 and 812 and one or more entry ways 814 (e.g., a door). Landscaping, such as a flowerbed 816, may be positioned around the structure 802. The structure 802 may be associated with multiple components and corresponding systems for monitoring and controlling the components. For example, the structure 802 may be associated with an irrigation system 818, an alarm system 820, a security system 822, an environmental control system 824, and a lighting system 826. It is understood that each of the systems 818, 820, 822, 824, and 826 may represent multiple systems or subsystems. For example, the alarm system 820 may represent a fire alarm system and a security alarm system, while the lighting system 826 may represent an interior lighting system and an exterior lighting system.

The irrigation system 818 may be configured to control and monitor the provision of moisture to the flowerbed 816 and other exterior landscaping and interior plant arrangements (not shown). The alarm system 820 may be configured to control and monitor safety components (e.g., fire alarms) within the structure 802, as well as security alarms (e.g., a burglar alarm on the door 814 to indicate unauthorized entry or an alarm on an interior door to control access to a room or office suite). The security system 822 may be configured to control and monitor cameras, motion sensors, and similar security devices, and may also control and monitor security alarms in some embodiments. The environmental control system 824 may be configured to control and monitor heating and air conditioning facilities. The lighting system 826 may be configured to control and monitor interior and exterior lighting of the structure 802.

The control module 804 may communicate with one or more of the systems 818, 820, 822, 824, and 826 separately, or may communicate with one or more of the systems via a general communication and/or power network positioned within the structure 802. In some embodiments, the control module 804 may communicate with one or more of the systems 818, 820, 822, 824, and 826 wirelessly.

The wireless device 806 may be used to communicate with the control module 804 in order for a user to request information from the control module and send instructions to the control module. Requesting information and sending instructions may be accomplished as previously described with respect to FIGS. 5-7, except that the wireless device 806 is communicating with the control module 804 in order to interact with the structure 802 and its associated components and systems, rather than with the vehicle 102.

For example, the wireless device 806 may be used to interact with the irrigation system 818 to regulate the operation of the system by setting times of operation and other parameters. The wireless device 806 may be used to interact with the alarm system 820 to monitor alarms, receive notifications that an alarm has been actuated, request information regarding an alarm, and arm/disarm security alarms. The wireless device 806 may be used to interact with the security system 822 to control and monitor cameras, motion sensors, and similar security devices. The wireless device 806 may be used to interact with the environmental control system 824 to monitor temperatures, modify temperature settings for heating and air conditioning facilities, and receive notifications of system malfunctions. The wireless device 806 may be used to interact with the lighting system 826 to control and monitor interior and exterior lighting (e.g., turn lights on and off).

As described above with reference to particular examples, functions controllable by a wireless device, such as the wireless devices 104 of FIG. 1 and 806 of FIG. 8, may be varied and may depend on factors such as the type of vehicle/structure and the level of interactivity provided. For example, both a vehicle and a structure may provide functions for actuating locking mechanisms for locking/unlocking various entry ways, while only a vehicle will have a steering function. In another example, a home or another structure may have different functionality than a vehicle, such as allowing a user to remotely monitor and/or control an irrigation system. Accordingly, the present disclosure may be applied to control systems in many different environments and is not limited to the examples provided above.

Although the preferred embodiment has been described in detail, it should be understood that various changes, substitutions and alterations can be made therein without departing from the spirit and scope of the invention as defined by the appended claims.

What is claimed is:

1. A system positioned within a vehicle for wireless communication between the vehicle and a wireless device comprising:
a wireline interface coupled to a plurality of vehicle components via a wireline connection to a communications network positioned within the vehicle;
a wireless interface configured to send and receive wireless signals; and
a control module having:
a processor coupled to the wireline and wireless interfaces; and
a memory coupled to the processor, wherein the memory includes a plurality of instructions for execution by the processor, the instructions including
instructions for obtaining information regarding a state of at least one of the plurality of vehicle components via the wireline interface based on a first instruction received from the wireless device via the wireless interface;
instructions for sending at least a portion of the obtained information to the wireless device via the wireless interface; and
instructions for sending a control signal to at least one of the plurality of vehicle components via the wireline interface based on a second instruction received from the wireless device via the wireless interface.

2. The system of claim 1 further comprising instructions for authenticating at least one security credential received from the wireless device via the wireless interface.

3. The system of claim 1 further comprising instructions for formatting the portion of the obtained information based on the Wireless Application Protocol (WAP) prior to sending the portion of the obtained information to the wireless device via the wireless interface.

4. The system of claim 1 further comprising instructions for communicating with a cell network via the wireless interface.

5. The system of claim 1 further comprising instructions for providing a wireless access point via the wireless interface.

6. The system of claim 1 further comprising instructions for segregating functions provided by the control module into a plurality of security levels, wherein access to a particular one of the functions is based on the security level associated with the function.

7. The system of claim 1 further comprising instructions for activating or deactivating at least one function provided by the control module based on a third instruction received from the wireless device via the wireless interface.

8. The system of claim 1 wherein the control module includes the wireline and wireless interfaces.

9. A remote access system for a vehicle comprising:
a plurality of vehicle components;
a plurality of vehicle control systems, wherein each of the plurality of vehicle control systems is associated with at least one of the plurality of vehicle components;
a vehicle communication network coupled to the plurality of vehicle control systems; and
a control module coupled to the vehicle communication network, the control module having
a first communication interface coupled to the vehicle communication network and a second communication interface, wherein at least the second communication interface is wireless;
a processor coupled to the first and second communication interfaces; and
a memory coupled to the processor, wherein the memory includes a plurality of instructions for execution by the processor, the instructions including
instructions for communicating with a Wireless Application Protocol (WAP) enabled wireless device via the wireless communication interface, wherein communicating with the wireless device includes receiving a request from the wireless device and responding to the request with information;
instructions for processing the request from the wireless device to determine the information being requested; and
instructions for obtaining the information being requested from at least one of the plurality of vehicle control systems.

10. The remote access system of claim 9 further comprising an interactive display coupled to the control module, wherein interaction with the control module may be performed via either the wireless device or the interactive display.

11. The remote access system of claim 9 further comprising instructions for monitoring one of the plurality of vehicle control systems;
detecting an event occurring in the monitored vehicle control system; and
pushing a message to the wireless device after detecting the event, wherein the message indicates that the event has occurred.

12. The remote access system of claim 11 further comprising instructions for performing a predefined action upon detecting the event, wherein performing the predefined action includes sending an instruction to one of the plurality of vehicle control systems.

13. The remote access system of claim 9 further comprising instructions for preventing at least one function of one of the plurality of vehicle control systems from being actuated via the second communication interface.

14. The remote access system of claim 9 further comprising instructions for assigning a security level to at least one function of one of the plurality of vehicle control systems, wherein the assigned security level defines whether an access code is required before permitting actuation of the function via the second communication interface.

15. The remote access system of claim 9 further comprising instructions for formatting communications transmitted via the second communication interface using WAP parameters.

16. The remote access system of claim 15 further comprising a Wireless Application Environment (WAE) server, wherein the control module uses the WAE server to perform the WAP formatting.

17. The remote access system of claim 9 further comprising a hypertext transfer protocol (HTTP) server configured to communicate with a WAP gateway, wherein communications transmitted via the second communication interface to the wireless device are sent through the HTTP server and the WAP gateway.

18. A remote access system for a building comprising:
a plurality of control systems associated with the building;
a communication network coupled to the plurality of control systems; and
a control module having
a communication interface coupled to the communication network, wherein the communication interface includes at least a wireless portion configured to receive and transmit wireless signals;
a processor coupled to the communication interface; and
a memory coupled to the processor, wherein the memory includes a plurality of instructions for execution by the processor, the instructions including
instructions for communicating with a Wireless Application Protocol (WAP) enabled wireless device via the wireless portion of the communication interface, wherein communicating with the wireless device includes receiving a request from the wireless device; and
instructions for performing at least one action in response to the request, wherein the instructions for performing the at least one action include instructions for identifying one of the plurality of control systems corresponding to the at least one action and instructions for sending a message to the identified control system to initiate the at least one action.

19. The remote access system of claim 18 further comprising instructions for formatting communications transmitted via the wireless portion of the communication interface using WAP parameters.

20. The remote access system of claim 19 further comprising a Wireless Application Environment (WAE) server, wherein the control module uses the WAE server to perform the WAP formatting.

21. The remote access system of claim 18 further comprising a hypertext transfer protocol (HTTP) server configured to communicate with a WAP gateway, wherein communications transmitted via the wireless portion of the communication interface are sent to the wireless device are sent through the HTTP server and the WAP gateway.

22. The remote access system of claim 18 wherein the plurality of control systems include at least one of an irrigation system, an alarm system, a security system, an environmental control system, and a lighting system.

23. The remote access system of claim 18 further comprising instructions for assigning a security level to at least one of the plurality of control systems, wherein the assigned security level defines whether an access code is required before permitting access to the corresponding control system via the wireless portion of the communication interface.
